(19) United States
(12) Patent Application Publication
(10) Pub. No.: US 2007/0025789 A1
(43) Pub. Date: Feb. 1, 2007

(54) Image forming apparatus using thermal print head

(76) Inventor: Yong-duk Lee, Gunpo-si (KR)

Correspondence Address: STANZIONE & KIM, LLP, 919 18TH STREET, N.W., SUITE 440, WASHINGTON, DC, 20006, US

(21) Appl. No.: 11/411,025

(22) Filed: Apr. 26, 2006

(30) Foreign Application Priority Data
Jul. 26, 2005 (KR) 2005-67847

(51) Int. Cl. B41J 13/076; B41J 3/60; B41J 13/10

(52) U.S. Cl. 400/188; 400/120.01; 400/642

(57) ABSTRACT

An image forming apparatus using a thermal printing head, the image forming apparatus including a printing unit having a thermal printing head to print an image by applying heat to a medium and a platen roller facing the thermal printing head to support the medium, a conveying unit to convey the medium at a predetermined printing speed, and a guide roller disposed between the conveying unit and the printing unit to guide the medium, the guide roller having a curved portion formed in a width direction of the medium.

### CROSS-REFERENCE TO RELATED APPLICATIONS

This application claims priority under 35 U.S.C. §119(a) from Korean Patent Application No. 10-2005-0067847, filed on Jul. 26, 2005, in the Korean Intellectual Property Office, the disclosure of which is incorporated herein in its entirety by reference.

### BACKGROUND OF THE INVENTION

1. Field of the Invention

The present general inventive concept relates to an image forming apparatus, and more particularly, to an image forming apparatus using a thermal printing head (TPH).

2. Description of the Related Art

FIG. 1 is a configurational view illustrating a conventional image forming apparatus using a thermal print head. In FIG. 1, a spring 4 pushes a thermal printing head (TPH) 51 toward a platen roller 52 in order to form a printing nib N. When a medium 10 on which an ink layer presenting a predetermined color by reacting with heat is formed passes along the printing nib N, the TPH 51 applies heat to the medium 10 to print an image. A conveying unit 40 conveys the medium 10 at a predetermined printing speed. As illustrated in FIG. 2, a heating line 56 is provided on the TPH 51 of FIG. 1. A plurality of heating elements are arranged in the heating line 56 to heat the medium 10 according to image information. As illustrated by a solid line in FIG. 2, an ideal heating line 56 is a straight line in a width direction of the medium 10. However, the heating line 56 is actually a convex or concave line toward the conveying unit 40 due to an error in a manufacturing process, as respectively illustrated by a dotted line 56a and a dotted chain line 56b in FIG. 2.

As illustrated in FIG. 3, an acting line 19 of an elastic force that the spring 4 exerts on the medium 10 at the printing nib N is a straight line. Accordingly, in a case where the heating line of the TPH is the straight heating line 56, the heating line 56 matches the acting line 19, so that a density in the width direction of the printed image is uniform. However, in a case where the heating line of the TPH is one of the curved heating lines 56a and 56b, the heating lines 56a and 56b do not match the acting line 19. Namely, in a case where the heating line of the TPH is the heating line 56a which is convex toward the conveying unit 40, a center portion of a printed image in the width direction thereof is obscure. Further, in a case where the heating line of the TPH is the heating line 56b which is concave toward the conveying unit 40, both edges of the printed image in the width direction thereof are obscure.

### SUMMARY OF THE INVENTION

The present general inventive concept provides an image forming apparatus using a thermal printing head capable of implementing a uniform printing density in a width direction with a simple structure.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing an image forming apparatus, including a printing unit having a thermal printing head to print an image by applying heat onto a medium, and a platen roller facing the thermal printing head to support the medium, a conveying unit to convey the medium at a predetermined printing speed, and a guide roller disposed between the conveying unit and the printing unit to guide the medium, the guide roller having a curved portion formed in a width direction of the medium.

The curved portion of the guide roller may have a positive curvature when a heating line of the thermal printing head is convex toward the guide roller, and a negative curvature in a case where the heating line of the thermal printing head is concave toward the guide roller.

In addition, the thermal printing head may be transferable to a first position facing a first surface of the medium and a second position facing a second surface opposite to the first surface. In addition, the thermal printing head may be transferable to the first and second positions by revolving around the platen roller. In addition, the guide roller may include first and second guide rollers to guide the medium, in a case where the thermal printing head is located at the first and second positions, respectively.

The foregoing and/or other aspects and utilities of the present general inventive concept may also be achieved by providing an image forming apparatus, including a printing unit including a thermal print head to form an image on a medium as the medium is conveyed therethrough and to heat the medium according to image information, and a guide unit to bias the medium along a widthwise direction as the medium is being conveyed so that a curvature of the width of the medium corresponds with a curvature of a line in which the image information is heated.

The guide unit can include at least one guide roller curved along a lengthwise direction thereof to transform an area on the medium upon which the printing unit exerts a force to have a shape that is substantially the same as a shape of the heating line. The at least one guide roller can be concave or convex along a lengthwise direction thereof. The at least one guide roller can include a plurality of guide rollers. At least one of the plurality of guide rollers can be concave along a lengthwise direction thereof, and at least another of the plurality of guide rollers can be convex along a lengthwise direction thereof. The heating line can be curved in a lengthwise direction of the thermal print head, and a distance between a center portion of the heating line and an edge portion of the heating line in a conveying direction is less than about 100 μm. The printing unit can further include a platen roller to form a printing nib with the thermal print head, and an elastic member to push the thermal print head toward the platen roller to exert the force on the medium and to form the printing nib. The printing unit can further include a conveying unit to convey the medium to and from the thermal print head. The thermal print head can be rotatable around the platen roller. The printing unit can further include a rotational guide to guide the medium to the printing nib. The printing unit can further include a motor to rotate the platen roller.

The foregoing and/or other aspects and utilities of the present general inventive concept may also be achieved by providing a conveying unit useable in an image forming apparatus having a thermal print head, the conveying unit including a conveying member to convey a printing medium to and from the thermal print head, and a guide member to bias the printing medium along a widthwise direction as the medium is being conveyed so that a curvature of the width of the medium corresponds with a curvature of a heating line on the thermal print head.

The foregoing and/or other aspects and utilities of the present general inventive concept may also be achieved by providing a method of printing an image using an image forming apparatus having a thermal print head, including forming an image on a medium as the medium is conveyed through the thermal print head and heating the medium according to image information, and biasing the medium along a widthwise direction as the medium is being conveyed so that a curvature of the width of the medium corresponds with a curvature of a line in which the image information is heated.

The forming of the image on the medium can include forming an image on a first surface of the medium as the medium is conveyed through the thermal print head and heating the first surface of the medium according to the image information, and the biasing of the medium can include transforming an area on the first surface of the medium upon which the printing unit exerts a force to have a shape that is substantially the same as a shape as the heating line. The method can further include rotating the thermal print head 180°, forming an image on a second surface of the medium as the medium is conveyed through the thermal print head and heating the second surface of the medium according to the image information, and transforming an area on the second surface of the medium upon which the printing unit exerts a force to have a shape that is substantially the same as the shape of the heating line. The heating line can be curved in a length direction. A distance between a center portion of the curved heating line and an edge portion of the curved heating line can be less than about 100 μm. The curved heating line can have a convex or a concave shape. The method can further include ejecting the medium having the printed images on the first and second surfaces thereof from the image forming apparatus.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a configurational view illustrating a conventional image forming apparatus using a thermal print head;

FIG. 2 is a view illustrating heating lines of the thermal print head of FIG. 1;

FIG. 3 is a view illustrating an acting line of a medium of FIG. 1;

FIG. 4 is a configurational view illustrating an image forming apparatus using a thermal print head according to an embodiment of the present general inventive concept;

FIGS. 5A and 5B are plane views illustrating a guide roller of the image forming apparatus of FIG. 4 having positive and negative curvatures, respectively;

FIGS. 6A, 6B, and 6C are a perspective view, a side view, and a plane view, respectively, illustrating changes in a shape of an acting line using the guide roller illustrated in FIG. 5A;

FIGS. 7A, 7B, and 7C are a perspective view, a side view, and a plane view, respectively, illustrating changes in a shape of an acting line using the guide roller illustrated in FIG. 5B;

FIGS. 8A and 8B are configurational views illustrating an image forming apparatus using a single TPH according to an embodiment of the present general inventive concept; and

FIG. 9 is a cross section view illustrating a medium according to embodiments of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

FIG. 4 is a configurational view illustrating an example of an image forming apparatus according to an embodiment of the present general inventive concept. A printing unit 150 and a conveying unit 140 are illustrated in FIG. 4. The printing unit 150 can include a thermal printing head (TPH) 151 and a platen roller 152. An elastic member 83 can be included to push the TPH 151 toward the platen roller 152. The platen roller 152 is slightly deformed by contacting the TPH 151, thereby forming a printing nib N. A knock-up plate 71 can be rotatably provided in a paper feeding cassette 70. A medium 110 can be mounted on the knock-up plate 71. A pick-up roller 63 to pick up the medium 110 can be provided on the knock-up plate 71. The conveying unit 140 can convey the medium 10 at a predetermined printing speed in first and second directions A1 and A2. The conveying unit 140 can include a conveying roller 141 and an idle roller 142 engaged with the conveying roller 141. An ejecting unit 60 can be included to eject the medium 10 and can include an ejecting roller 61 engaged with the pick-up roller 63 to rotate and an idle roller 62 engaged with the ejecting roller 61.

One or a plurality of ink layers presenting predetermined colors by reacting with heat can be provided on a surface M1 of the medium 110. The medium 110 picked up from the paper feeding cassette 70 by the pick-up roller 63 can be conveyed in the first direction A1 by the conveying unit 140 and can be supplied to the printing unit 150. After the medium 110 has been supplied to the printing unit 150, the conveying unit 140 can convey the medium 110 in the second direction A2. The TPH 151 can apply heat corresponding to image information to the medium 110 to print an image. The printed medium 110 can be ejected by the ejecting unit 60. By repeating the above-mentioned process several times, the heat is sequentially applied to a plurality of ink layers so that a color image can be printed.

Since the pick-up roller 63 and the ejecting roller 61 can be engaged with each other to rotate and the rotation direction of the pick-up roller 63 changes, after the end of the picked up medium 110 reaches the conveying unit 140, the knock-up plate 71 can descend to separate the medium 110 mounted on the knock-up plate 71 from the pick-up roller 63. Further, in a case where the platen roller 152 is rotated not by a driving motor(not illustrated) but by contacting the medium 110 conveyed by the conveying unit 140, the TPH 151 and the platen roller 152 can be separated from each other while the conveying unit 140 conveys the medium 110 in the first direction A1 in order to supply the medium 110 to the printing unit 150, and the TPH 151 and the platen roller 152 can be elastically engaged with each other to form the printing nib N while the conveying unit 140 conveys the medium 110 in the second direction A2.

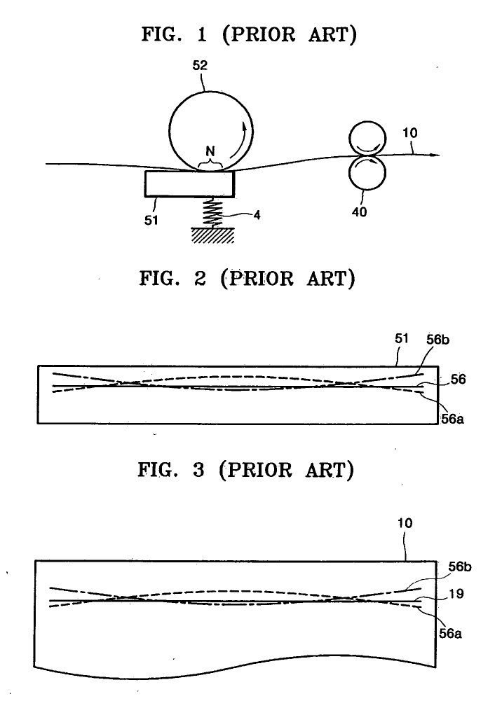

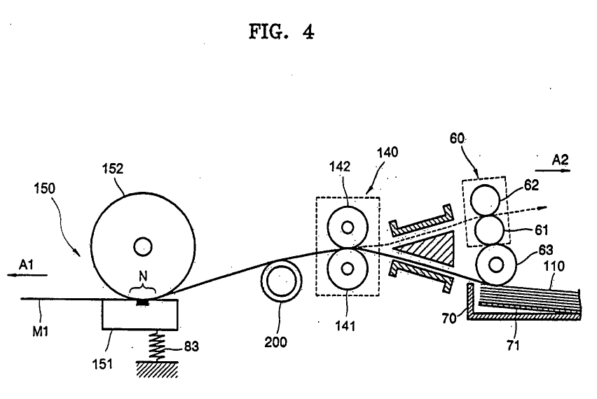

As described above with reference to FIGS. 1 to 3, in the conventional image forming apparatus, the acting line 19 of the elastic force of the spring 4 exerted on the medium 10 in the printing nib N is a straight line, and the TPH 51 may have the heating lines 56a and 56b that are curved lines. As a result, using the conventional image forming apparatus, printing densities at a center and edge of the printed image in the width direction thereof may be different from each other due to a mismatch between the acting line 19 and the heating line 56a and 56b.

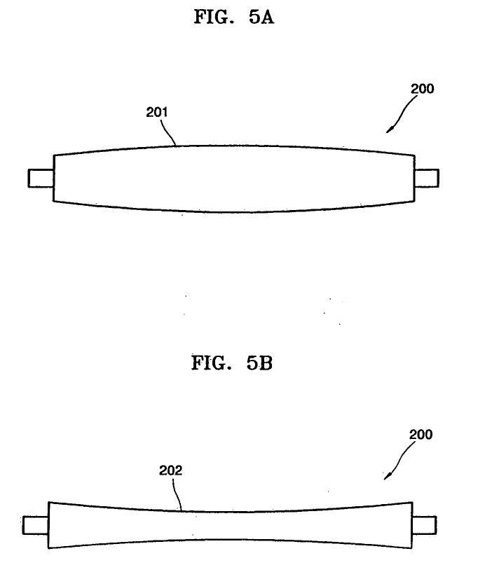

To avoid at least these problems associated with the conventional image forming apparatus, the image forming apparatus of FIG. 4 includes a guide roller 200 disposed between the conveying unit 140 and the printing unit 150 to guide the medium 110. The guide roller 200 can include a curved portion 201 having a convex shape (i.e., having a positive curvature) as illustrated in FIG. 5A, or a curved portion 202 having a concave shape (i.e., having a negative curvature) as illustrated in FIG. 5B to transform an acting line of the medium 110 to a shape substantially matching a shape of a heating line of the TPH 151 to obtain a uniform printing density in a width direction of the medium 110.

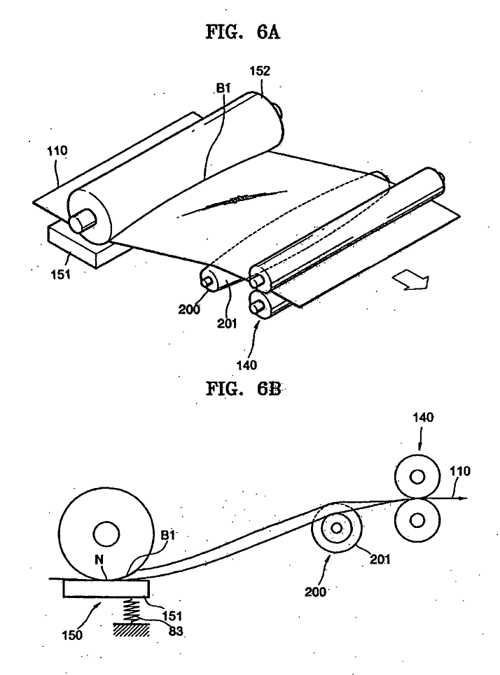

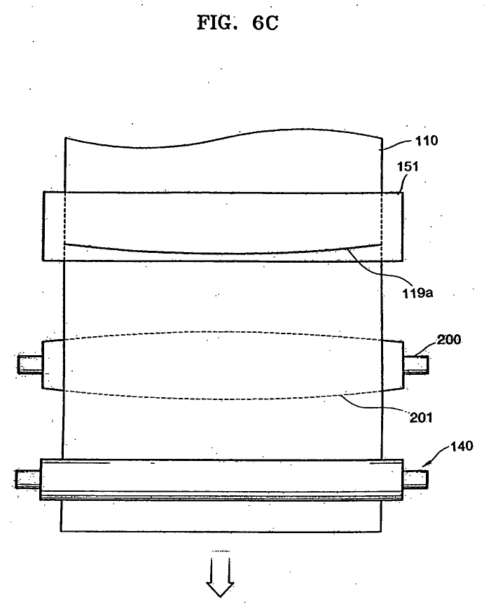

Referring to FIGS. 6A, 6B and 6C, a curve having a convex shape is formed in the width direction in the medium 110 between the conveying unit 140 and the printing unit 150 by the guide roller 200 having the curved portion 201. Due to the curve, an acting line 119a in the printing nib N is not a straight line but a curved line, as illustrated in FIG. 6C, which can be visualized by projecting a line on a plane (indicated by B1 in FIGS. 6A and 6B) where the platen roller 152 contacts the medium 110. A shape of the acting line 119a is almost equal to that of the heating line of the TPH 151 that is convex toward the conveying unit 40. Accordingly, when the heating line of the TPH 151 has the convex shape, the acting line 119a having the convex curved line shape similar to the convex heating line can be formed by using the guide roller 200 having the convex curved portion, resulting in a printed image having a uniform density in the width direction thereof.

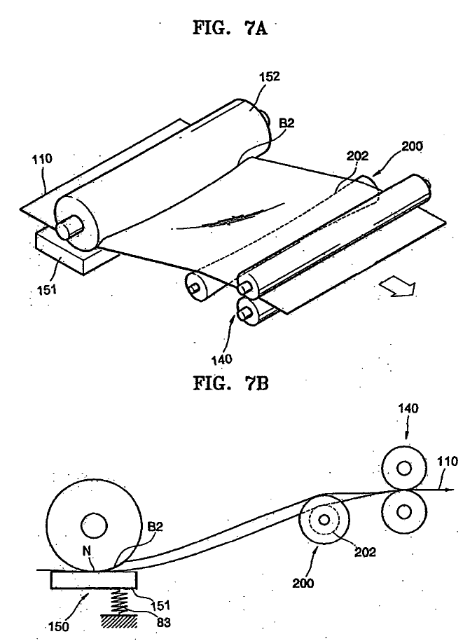

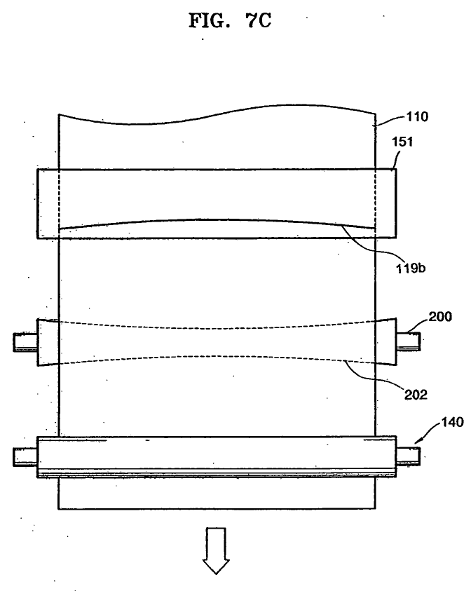

Referring to FIGS. 7A, 7B and 7C, a curve having a concave shape is formed in the width direction in the medium 110 between the conveying unit 140 and the printing unit 150 by the guide roller 200 having the curved portion 202. Due to this curve, an acting line 119b on the printing nib N is not a straight line but a curved line, as illustrated in FIG. 7C, which can be visualized by projecting a line on a plane (indicated as B2 in FIGS. 7A and 7B) where the platen roller 152 contacts the medium 110. A shape of the acting line 119b is almost equal to that of the heating line of the TPH 151 that is concave toward the conveying unit 140. Accordingly, when the heating line of the TPH 151 has the concave shape, the acting line 119b having the concave curved line shape similar to the heating line can be formed by using the guide roller 200 having the concave curved portion, resulting in a printed image having a uniform density in the width direction thereof.

A difference in a conveying direction of the medium 110 between a center and an edge of the convex and concave heating lines of the TPH 151 can be less than about 100 μm. Furthermore, the error can be almost constant in various TPHs 151 produced by a same manufacturer. Accordingly, an absolute value of the curvature of each of the curved portions 201 and 202 may be properly selected by an experiment so that the shape of the acting lines 119a and 119b are similar to that of the heating lines of the TPH 151.

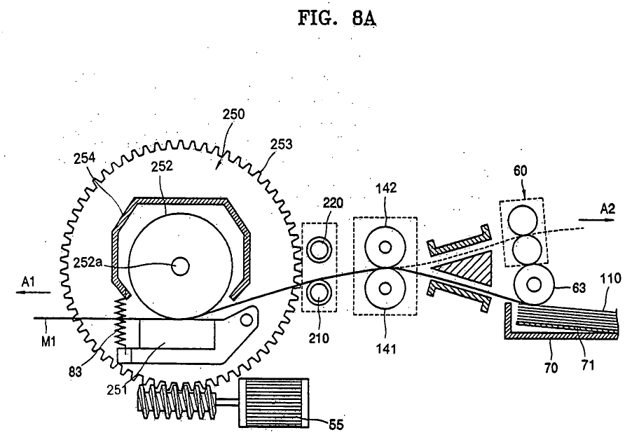

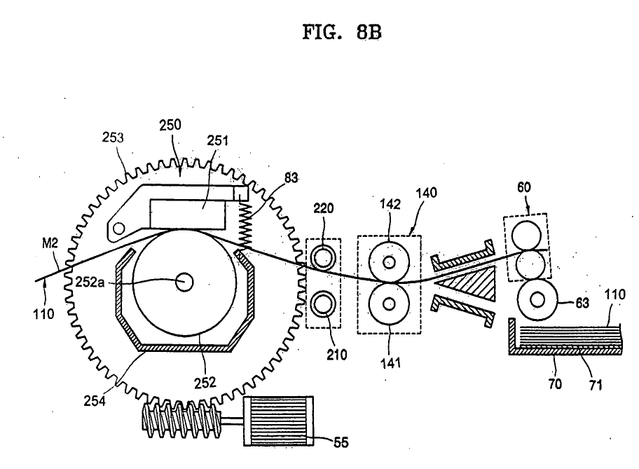

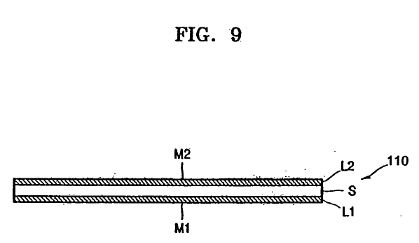

FIGS. 8A and 8B are configurational views illustrating an image forming apparatus according to another embodiment of the present general inventive concept. In this embodiment, a single TPH 251 can be transferred to a first position facing a first surface M1 of a media 110 and a second position facing a second surface M2 of the media 110 to print an image on both surfaces of the medium 110 using the single TPH 251. As illustrated in FIGS. 8A and 8B, the TPH 251 can be provided in a supporting bracket 253. The supporting bracket 253 can be rotatable about a rotational axis 252a of a platen roller 252. A motor 55 can be included to rotate the supporting bracket 253 to transfer the TPH 251 to the first position as illustrated in FIG. 8A and the second position as illustrated in FIG. 8B. A rotational guide 254 can be coupled to the supporting bracket 53, such that when the TPH 251 is located at the first and second positions, the rotational guide 54 can guide the medium 110 conveyed in the first direction to the printing nib N by a conveying unit 140.

First and second guide rollers 210 and 220 can be provided between the conveying unit 140 and the printing unit 250 to form curved acting lines having a shape corresponding to a shape of a heating line of the TPH 251. The first guide roller 210 can form a curve in the medium 110 when the TPH 251 is located at the first position, as illustrated in FIG. 8A. The second guide roller 220 can form a curve in the medium 110 when the TPH 251 is located at the second position, as illustrated in FIG. 8B. The first and second guide rollers 210 and 220 can function separately or in combination to transform an acting line of the medium 110 to a shape substantially matching a shape of a heating line of the TPH 251 to obtain a uniform printing density in a width direction of the medium 110. A structure for allowing the TPH 251 to transfer to the first and second positions is not limited to the example illustrated in FIGS. 8A and 8B.

The medium 110 may have the structure illustrated in FIG. 9. Ink layers L1 and L2 of a predetermined color can be formed on both surfaces of a base sheet S, for example, the first and second surfaces M1 and M2. Each ink layer L1 and L2 may have a single-layer structure for representing a single color or a multi-layer structure for representing two or more colors. For example, the ink layer L1 on the first surface M1 may be a two-layer structure for representing yellow and magenta colors, and the ink layer L2 on the second surface M2 may be a single layer structure for representing a cyan color. Also, the ink layers L1 and L2 may represent the same color. The medium 110 with such structures has been disclosed in US Pat. No. 2003-0125206. However, the medium 110 is not limited to the structure of FIG. 9.

A duplex printing process will now be explained with reference to FIGS. 8A and 8B. As illustrated in FIG. 8A, the TPH 251 is located at the first position. The medium 110 picked up from the paper feeding cassette 70 by the pick-up roller 63 is conveyed in the first direction A1 by the conveying unit 140. At this time, the TPH 251 can be separated from the platen roller 252. The medium 110 can be conveyed between the TPH 251 and the platen roller 252. When the medium 110 arrives at a printing start position, the conveying unit 140 can stop the conveyance of the medium 110, and the TPH 251 can approach the platen roller 252. The elastic member 83 can push the TPH 251 to form the printing nib N. The conveying unit can convey the medium 110 in the second direction A2 at a predetermined printing speed. The TPH 251 can print the image by applying heat onto the first surface M1 of the medium 110. The medium 110 can be temporarily ejected by the ejecting unit 60. When the printing on the first surface M1 of the medium 110 is finished, the conveying unit 140 can stop the conveyance of the medium 110.

The TPH 251 can then move to face the second surface M2 of the medium 110. The motor 55 allows the supporting bracket 253 to rotate about the rotational axis 252a of the platen roller 252, thereby positioning the TPH 252 at the second position as illustrated in FIG. 8B. At this time, the rotational guide 54 also rotates together with the supporting bracket 253. The TPH 251 can be separated from the platen roller 252. The conveying unit 140 can convey the medium 110 in the first direction A1 again, thereby positioning the medium 110 at the printing start position. The TPH 251 approaches the platen roller 252. The elastic member 83 pushes the TPH 251 to form the printing nib N. The conveying unit 140 can convey the medium 110 in the second direction A2 at a predetermined printing speed. The TPH 251 can print the image by applying heat onto the second surface M2 of the medium 110. The medium 110 having the printed image can then be ejected by the ejecting unit 60.

Referring to FIG. 9, the base sheet S of the medium 110 can be a transparent material, and an opaque film may be formed in the outer surface of either of the ink layers L1 and L2, for example, the ink layer L1. By positioning the TPH 251 at the first position and applying heat to the ink layer L1, the yellow and the magenta are represented. Furthermore, by positioning the TPH 251 at the second position and applying heat to the ink layer L2, the cyan is represented. The cyan, magenta and yellow images are overlapped to form a complete color image on the ink layer L2.

Also referring to FIG. 9, the base sheet S can be an opaque material, and ink layers having the same color can be formed on the first and second surfaces M1 and M2, making it possible to print different images on the first and second surfaces M1 and M2 using the duplex printing process.

As mentioned above, an image forming apparatus according to various embodiments of the present general inventive concept makes it possible to match an acting line of an elastic force applied to a TPH with a shape of a heating line of the TPH by forming a curve in a medium using a guide roller. Accordingly, the image forming apparatus is capable of obtaining a uniform printing density in a width direction of a medium. In addition , by allowing the TPH to transfer to position facing both surfaces of the medium, the image forming apparatus can be a low-cost image forming apparatus in which duplex and color prints are possible.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming apparatus, comprising:
a printing unit having a thermal printing head to print an image by applying heat onto a medium, and a platen roller facing the thermal printing head to support the medium;
a conveying unit to convey the medium at a predetermined printing speed; and
a guide roller disposed between the conveying unit and the printing unit to guide the medium, the guide roller having a curved portion formed in a width direction of the medium.

2. The apparatus according to claim 1, wherein the curved portion has a positive curvature when a heating line of the thermal printing head is convex toward the guide roller, and a negative curvature when the heating line of the thermal printing head is concave toward the guide roller.

3. The apparatus according to claim 2, wherein the thermal printing head is transferable to a first position facing a first surface of the medium, and a second position facing a second surface opposite to the first surface.

4. The apparatus according to claim 3, wherein the thermal printing head is transferable to the first and second positions by revolving around the platen roller.

5. The apparatus according to claim 4, wherein the guide roller includes first and second guide rollers to guide the medium when the thermal printing head is located at the first and second positions, respectively.

6. An image forming apparatus, comprising:
a printing unit including a thermal print head to form an image on a medium as the medium is conveyed therethrough and to heat the medium according to image information; and
a guide unit to bias the medium along a widthwise direction as the medium is being conveyed so that a curvature of the width of the medium corresponds with a curvature of a line in which the image information is heated.

7. The apparatus according to claim 6, wherein:
the guide unit comprises at least one guide roller curved along a lengthwise direction thereof to transform an area on the medium upon which the printing unit exerts a force to have a shape that is substantially the same as a shape of the heating line.

8. The image forming apparatus according to claim 7, wherein the at least one guide roller is concave or convex along a lengthwise direction thereof.

9. The image forming apparatus according to claim 7, wherein the at least one guide roller comprises a plurality of guide rollers.

10. The image forming apparatus according to claim 9, wherein:
at least one of the plurality of guide rollers is concave along a lengthwise direction thereof; and
at least another of the plurality of guide rollers is convex along a lengthwise direction thereof.

11. The image forming apparatus according to claim 7, wherein:
the heating line is curved in a lengthwise direction of the thermal print head; and
a distance between a center portion of the heating line and an edge portion of the heating line in a conveying direction is less than about 100 μm.

12. The image forming apparatus according to claim 7, wherein the printing unit further comprises:
a platen roller to form a printing nib with the thermal print head; and
an elastic member to push the thermal print head toward the platen roller to exert the force on the medium and to form the printing nib.

13. The image forming apparatus according to claim 7, wherein the printing unit further comprises:
a conveying unit to convey the medium to and from the thermal print head.

14. The image forming apparatus according to claim 12, wherein the thermal print head is rotatable around the platen roller.

15. A conveying unit useable in an image forming apparatus having a thermal print head, the conveying unit comprising:
a conveying member to convey a printing medium to and from the thermal print head; and
a guide member to bias the printing medium along a widthwise direction as the medium is being conveyed so that a curvature of the width of the medium corresponds with a curvature of a heating line on the thermal print head.

16. A method of printing an image using an image forming apparatus having a thermal print head, comprising:
forming an image on a medium as the medium is conveyed through the thermal print head and heating the medium according to image information; and
biasing the medium along a widthwise direction as the medium is being conveyed so that a curvature of the width of the medium corresponds with a curvature of a line in which the image information is heated.

17. The method according to claim 16, wherein:
the forming of the image on the medium comprises forming an image on a first surface of the medium as the medium is conveyed through the thermal print head and heating the first surface of the medium according to the image information; and
the biasing of the medium comprises transforming an area on the first surface of the medium upon which the printing unit exerts a force to have a shape that is substantially the same as a shape as the heating line.

18. The method according to claim 17, further comprising:
rotating the thermal print head 180°;
forming an image on a second surface of the medium as the medium is conveyed through the thermal print head and heating the second surface of the medium according to the image information; and
transforming an area on the second surface of the medium upon which the printing unit exerts a force to have a shape that is substantially the same as the shape of the heating line.

19. The method according to claim 17, wherein the heating line is curved in a length direction.

20. The method according to claim 19, wherein a distance between a center portion of the curved heating line and an edge portion of the curved heating line is less than about 100 μm.

21. The method according to claim 19, wherein the curved heating line has a convex or a concave shape.

22. The method according to claim 18, further comprising ejecting the medium having the printed images on the first and second surfaces thereof from the image forming apparatus.
